(19) United States
(12) Patent Application Publication
(10) Pub. No.: US 2022/0327252 A1
(43) Pub. Date: Oct. 13, 2022

(54) METHOD AND SYSTEM FOR COMPUTER AIDED DESIGN

(71) Applicant: Siemens Industry Software Inc., Plano, TX (US)

(72) Inventors: Douglas King, Peterborough (GB); Howard Mattson, Cambridge (GB); Jeremy Rogers, Cambridge (GB); Yanong Zhu, Cambridge (GB)

(21) Appl. No.: 17/763,714

(22) PCT Filed: Sep. 27, 2019
(86) PCT No.: PCT/EP2019/076198

§ 371 Date: Mar. 25, 2022

(51) Int. Cl. G06F 30/12; G06F 30/17

(52) U.S. Cl. CPC G06F 30/12; G06F 30/17; G06F 2111/04

(57) ABSTRACT

A method and system for computer aided design, (e.g., of products and other items), are disclosed herein. The method may include receiving a CAD model having a behavior defined by a plurality of relationships, receiving a user operation to edit a seed feature in the CAD model, and identifying a set of problem relationships from the plurality of relationships, wherein the set of problem relationships prevent implementation of the received user operation to the received CAD model. A category for each relationship in the set of problem relationships is selected. The behavior of the CAD model is reconfigured based on the selected category for each problem relationship by retaining any user-defined relationships, optionally retaining any optional relationships, and ignoring any relaxed relationships. The user operation is then performed according to the reconfigured behavior to produce a modified CAD model.

The present patent document is a § 371 nationalization of PCT Application Serial No. PCT/EP2019/076198, filed Sep. 27, 2019, designating the United States, which is hereby incorporated by reference.

### TECHNICAL FIELD

The present disclosure relates to a method and system for computer aided design, for example, of products and other items.

### BACKGROUND

There exist systems which manage data for products and other items, and which may be termed Product Data Management (PDM) systems. The data may include computer-aided design (CAD), visualization, and manufacturing systems as well as product lifecycle management (PLM) systems.

Such systems may include variational modelling systems such as the “Siemens NX” solutions provided by Siemens PLM solutions. A variational system describes the parameters of and relationships between features in an object model in terms of geometric constraints and dimensions. Such systems may then use a “solver” process to process these constraints and dimensions, along with a multitude of ancillary constraints and dimensions required to maintain design intent, and the entire model is solved simultaneously.

A system for modifying geometric relationships in a solid model is described in WO 2009/128895. A set of constraints may be calculated for a geometric model and a modified geometric model may be calculated based on the set of constraints. A variational system is described in WO 2014/008220. A CAD model having a plurality of features and constraints, including optional constraints is received. A user operation to manipulate a seed feature is received and the plurality of optional constraints are identified, sorted, and then applied. A modified CAD model is then produced by performing the user operation according to the applied constraints.

It is recognized that it may not be possible to perform the user operation because the system is over-constrained, for example as defined in most constraint solving systems.

An improved system is desirable.

### SUMMARY

To address these problems, a computer-implemented method is provided for designing a product using a CAD model, the method being implemented in a data processing system. The method includes receiving a CAD model having a behavior defined by a plurality of relationships; receiving a user operation to edit a seed feature in the CAD model; identifying a set of problem relationships from the plurality of relationships, wherein the set of problem relationships prevent implementation of the received user operation to the received CAD model; selecting a category for each relationship in the set of problem relationships, wherein the category is selected from user-defined, optional, and relaxed relationships, and wherein a user-defined relationship is a relationship defined by the user and optional and relaxed relationships are relationships which are not defined by the user with optional relationships representing more important behavior than the relaxed relationships; reconfiguring the behavior of the CAD model based on the selected category for each problem relationship by retaining any user-defined relationships; optionally retaining any optional relationships; and ignoring any relaxed relationships; and performing the user operation according to the reconfigured behavior to produce a modified CAD model.

The set of problem relationships may result in the behavior of the CAD model being over-defined. Over-defined may include both over-constrained in which the set of relationships define too many constraints and over-dimensioned in which the set of relations define too many dimensions within the model.

The use of optional and relaxed relationships allows the automatic reconfiguration of the behavior of the CAD model. The user operation will thus still be carried out but at least some of the relationships within the CAD model will be broken. Using a mixture of optional and relaxed relationships may allow a minimal number of relationships to be broken. Optionally retaining any optional relationships may include retaining an optional relationship when the user operation is not prevented by the optional relationship when carrying out the performing act and ignoring the optional relationship when the user operation is prevented by the optional relationship when carrying out the performing act. Ignoring the relaxed relationships means that these relationships are not applied when performing the user operation. It is possible that the relaxed relationships are still satisfied but they may be broken. By prioritizing the optional relationships above the relaxed relationships, (e.g., by trying to retain the optional relationships but ignoring the relaxed relationships), more of the higher priority relationships may be retained overall when implementing the user operation.

The method may further include identifying a second set of problem relationships in the reconfigured behavior, wherein the second set of problem relationships prevent the user operation being performed and repeating the selecting, reconfiguring and performing acts. Each set of problem relationships represents an over-defined region of the model. In other words, after addressing the first set of problem relationships, it is possible that there are other regions of the model which are over-defined. The method may thus be considered to be a propagation algorithm which acts through the identifying, selecting, and reconfiguring acts until the user operation may be fully performed.

Selecting the category from optional and relaxed relationships may include selecting the category from a look-up table listing relationships as optional or relaxed. Optional relationships may represent relationships which a user would more strongly prefer to keep than relaxed relationships, but the priority may change from model to model, e.g., based on the product being designed. The look-up table may be configurable to allow for behavioral changes. In certain examples, optional relationships may include geometrical relationships such as tangent-at-vertex, horizontal and vertical alignments, and relaxed relationships may include geometrical relationships such as parallel or tangential alignments or patterns. The optional category may include optional model relationships inherent from the model and optional editing relationships inherent from the user operation.

Optionally retaining any optional relationships may include sorting the optional relationships into an order in which the optional relationships are to be applied. Once sorted, the method may further include applying a sorted optional relationship which is first in the order in which the optional relationships are to be applied and retaining the applied sorted optional relationship only when applying the relationship does not prevent the user operation. The applying and retaining acts may be repeated to the sorted optional relationship which is next in the order in which the optional relationships are to be applied and so on until all optional relationships have been applied. Once an optional relationship has been applied, it may be considered to be removed from the order.

Any appropriate sorting may be applied. For example, sorting the optional relationships may be performed according to a distance from the seed feature to features corresponding to each of the optional relationships. The more distant optional relationships may be ordered before the closer optional relationships. Alternatively, or additionally, sorting the optional relationships may be performed to prioritize optional editing relationships before optional model relationships in the order in which the optional relationships are to be applied.

The method may further include outputting any optional or relaxed relationships which are broken when performing the user operation. This may allow a user to determine whether or not the automatic relaxing of the relationships is acceptable.

The method may further include storing the modified CAD model and/or the output broken relationships.

According to another aspect of the disclosure, a (non-transitory) computer readable medium carrying processor control code is provided, which, when implemented in a system, causes the system to carry out the method described above.

Another aspect of the present disclosure is a data processing system for designing a product using a CAD model. The system may include a processor configured to carry out the method described above.

A data processing system for designing a product using a CAD model is provided. The data processing system includes a processor configured to receive a CAD model having a behavior defined by a plurality of relationships; receive a user operation to edit a seed feature in the CAD model; identify a set of problem relationships from the plurality of relationships, wherein the set of problem relationships prevent implementation of the received user operation to the received CAD model; select a category for each relationship in the set of problem relationships, wherein the category is selected from user-defined, optional and relaxed and wherein a user-defined relationship is a relationship defined by the user and optional and relaxed relationships are relationships which are not defined by the user with optional relationships representing more important behavior than the relaxed relationships; reconfigure the behavior of the CAD model based on the selected category for each problem relationship by retaining any user-defined relationships, optionally retaining any optional relationships, and ignoring any relaxed relationships; and perform the user operation according to the reconfigured behavior to produce a modified CAD model.

The data processing system may further include storage for storing the modified CAD model and/or a look-up table listing relationships as optional or relaxed. The processor may be configured to select the category from optional and relaxed by selecting the category from the look-up table. The storage may be any suitable memory, e.g., non-volatile or volatile memory. The storage may be local to the processor, e.g., located within the same system, or may be remote from the processor, e.g., at a different location such as the cloud.

The data processing system may further include a display for outputting any optional or relaxed relationships which are broken when performing the user operation. The modified CAD model may also be output on the display. Any other suitable user interface may be used to display the modified model and/or the relationship list.

Merely as examples, the product may be a component of a valve assembly, a component of an engine, such as a connecting rod, a gear in a gear assembly, a component of an electric motor, an assembly of plates, nuts, bolts, and other components describing a washing machine. Once the modified CAD model has been output, the product may be manufactured based on the modified model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or, the phrases “associated with” and “associated therewith,” as well as derivatives thereof: may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

The above-mentioned attributes and other features and advantages of this disclosure and the manner of attaining them become more apparent and the disclosure itself is better understood by reference to the following description of embodiments of the invention taken in conjunction with the accompanying drawings, wherein like numbers designate like objects, and in which:

FIG. 1 depicts a schematic block diagram of a data processing system in which an embodiment may be implemented.

FIGS. 2A and 2B illustrate an example of a model before and after manipulation by a user.

FIG. 3 depicts a flowchart of a method which may be implemented in the system of FIG. 1.

FIGS. 4A and 4B illustrate a variation of the example model of FIG. 2A before and after processing according to the method of FIG. 3.

FIGS. 5A and 5B illustrate an alternative example model before and after processing according to the method of FIG. 3.

FIGS. 6A and 6B illustrate an alternative example model before and after processing according to the method of FIG. 3.

FIGS. 7A and 7B illustrate a variation of the example model of FIG. 6A before and after processing according to the method of FIG. 3.

FIGS. 8A and 8B illustrate a variation of the example model of FIG. 7A before and after processing according to the method of FIG. 3.

FIGS. 9A and 9B illustrate a variation of the example model of FIG. 2A before and after processing according to the method of FIG. 3.

FIGS. 10A and 10B illustrate another example model before and after processing according to the method of FIG. 3;

FIGS. 11A and 11B illustrate another example model before and after processing according to the method of FIG. 3.

FIG. 12A is a perspective view of an example of a valve assembly.

FIGS. 12B and 12C are perspective and side views of an example of a component within the valve assembly of FIG. 12A.

FIGS. 12D and 12E are perspective and side views of the component within the valve assembly of FIG. 12A after processing according to the method of FIG. 3.

### DETAILED DESCRIPTION

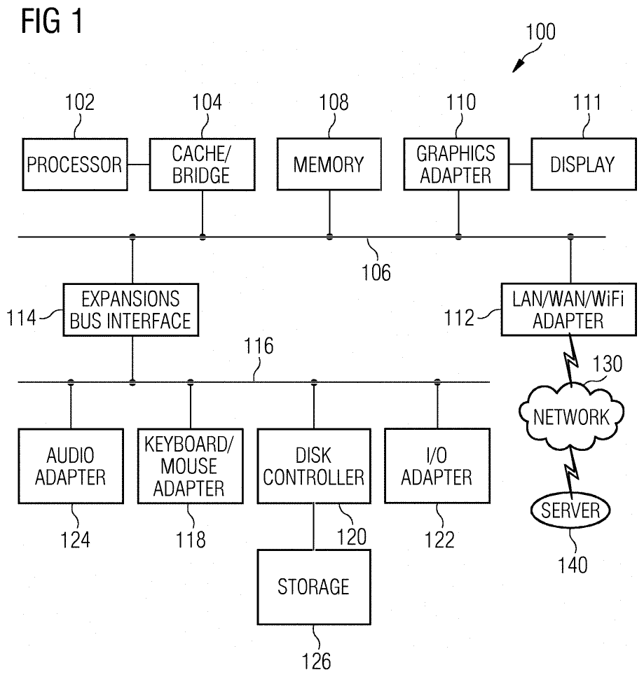

FIGS. 1 through 12E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

FIG. 1 depicts a block diagram of a data processing system in which an embodiment may be implemented, for example, as a PDM system particularly configured by software or otherwise to processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g., Wi-Fi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 may be connected to a storage 126, which may be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, track pointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 may be connected to a network 130 (not a part of data processing system 100), which may be any public or private data processing system network or combination of networks, as known to those of skill in the art, including the Internet. Data processing system 100 may communicate over network 130 with server system 140, which is also not part of data processing system 100, but may be implemented, for example, as a separate data processing system 100.

The system of FIG. 1 may be used to provide functionality for users to create 2D sketches that are used to form 3D models that represent engineering designs for manufacture. Within the sketching system, it is possible for the engineer to define relationships defining some aspects of the design, e.g., a dimension which defines a size of the design or feature within the design or geometric constraints between two features of the design. Additionally, the system may also be configured to identify other relationships which have not been specifically defined by the user but are nevertheless implemented by the system to control the behavior of the model when editing the model. These relationships may be termed implied relationships because they may be derived from features of the model itself. They may be identified when attempting to edit the model. Examples of the relationships which may be set by the user or are implied based on the model itself are:
A dimension of a feature within a model
A dimension of the overall model, e.g., length, width, height
Two or more lines within the model remain parallel to one another
Two lines within the model remain perpendicular to one another
Two or more lines within the model remain colinear with one another
A pattern is applied to one or more features
A straight line meeting a curved surface forms a tangent to the curved surface at the point of intersection
Two or more adjacent curved surfaces are part of concentric circles
A line within the model remains horizontal
A line within the model remains vertical
A line within the model remains in a fixed position

The list of relationships is configurable, so that relationships may be added or removed, for example, depending on the nature of the product being modelled.

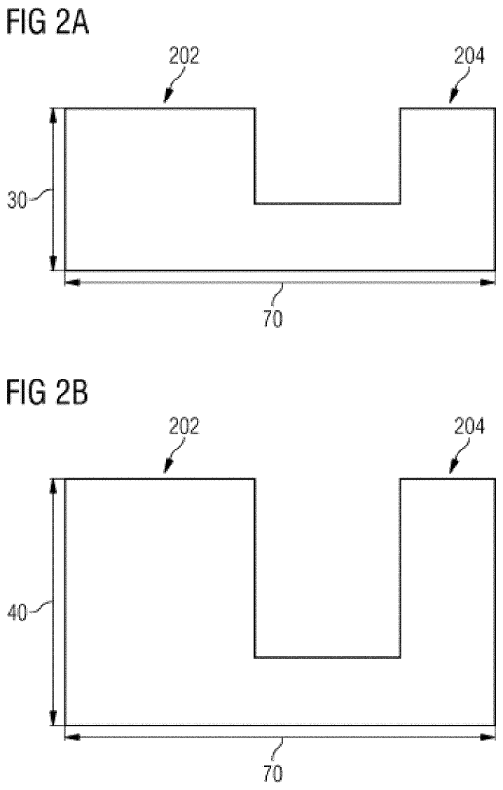

A simple example is illustrated in FIG. 2A. In this model, a user has defined (or placed) two dimensions to describe the height and width of the overall model (e.g., the 2D sketch). Merely, as an illustrative example, these dimensions are 30 for the vertical dimension and 70 for the horizontal direction. In addition to these user-defined relationships, the system may identify the implied relationship, which is the colinear relationship of the two upper lines 202, 204. The full set of relationships in the model is set out in the table below. The relationships define the behavior of the model when editing the model. The relationships may be termed constraints and the terms may be used interchangeably:

| Relationship/Constraint | Category (Type) |
|---|---|
| Horizontal dimension | User defined |
| Vertical dimension | User defined |
| Colinear relationship of 202, 204 | Implied |

When the user edits the vertical dimension from 30 to 40, thus moving line 202 upwards, the colinear relationship is also applied to move line 204 upwards. There are no relationships preventing the edit and thus there are no conflicting relationships. Accordingly, the set of relationships is not over-defined, and all relationships may be applied with the resulting amended model shown in FIG. 2B.

In more complex models, it will be appreciated that at least some of the relationships may conflict and a simple example is given by adding the relationship that line 204 is constrained to a fixed position. The set of relationships thus becomes:

| Relationship | Type |
|---|---|
| Horizontal dimension | User defined |
| Vertical dimension | User defined |
| Line 204 in fixed position | User defined |
| Colinear relationship of 202, 204 | Implied |

The amendment to the vertical dimension proposed by the user cannot be carried out in with this over-defined set of relationships because it is not possible to keep line 204 in a fixed position and colinear with the line 202 which is to be moved. It will be appreciated that in this simple example, a user may easily turn off the colinear relationship to achieve the desired user operation. However, in more complex situations it may be difficult, and time consuming for the user to identify the over-defining relationships that need to be removed to allow the desired user operation to be implemented.

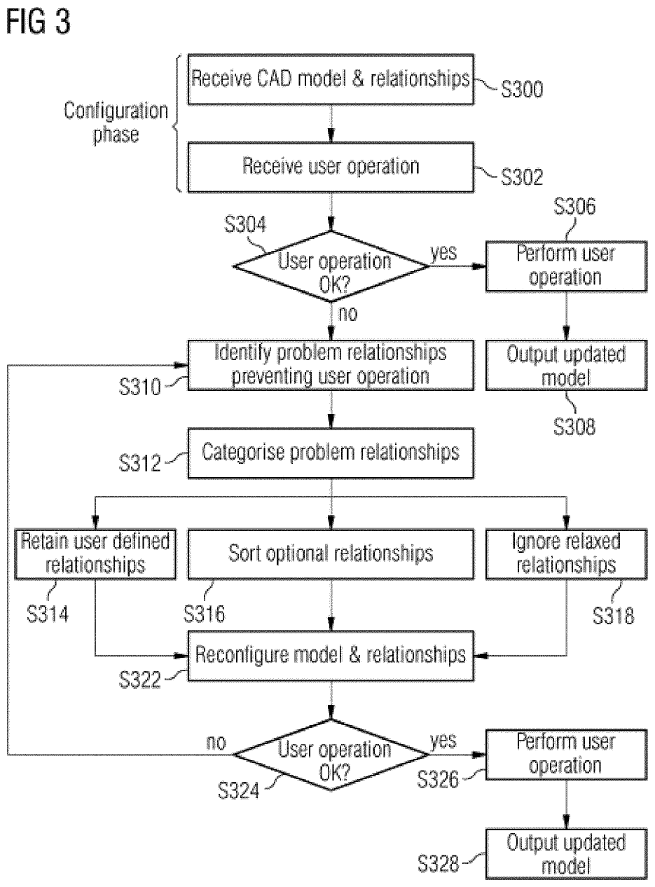

FIG. 3 is a flowchart of a method which may be implemented in the sketching system to aid the user by automatically relaxing certain relationships to enable the desired user operation to be implemented. The initial phase is a configuration phase which as illustrated in this example includes an act of receiving a CAD model having a plurality of features (e.g., lines/faces, vertices/intersection, curvature, etc.) with a set of relationships (act S300) and receiving a user operation to edit part of the CAD model (act S302). The part of the CAD model which the user is attempting to edit may be termed a seed feature and the change to this feature may require amendments to other features of the model to satisfy the plurality of relationships which define the dimensions of the model and how features of the model interact or are related to each other. This plurality of relationships may control the general behavior of the model in response to user operations.

A determination is made as to whether or not the user operation may be implemented (act S304) to edit the model and still retain all the relationships. In other words, a determination is made as to whether the desired behavior of the model may be retained following the application of the user operation. The relationships may only be identified at this stage, for example, from the information received with the CAD model. The relationships may be identified using standard techniques, for example by querying a solver such as the Siemens DCM solver, When the user operation may be applied with the retained behavior, for example, as in the example of FIG. 2A, the user operation is performed (act S306) and the updated model is output as shown in FIG. 2B (act S308).

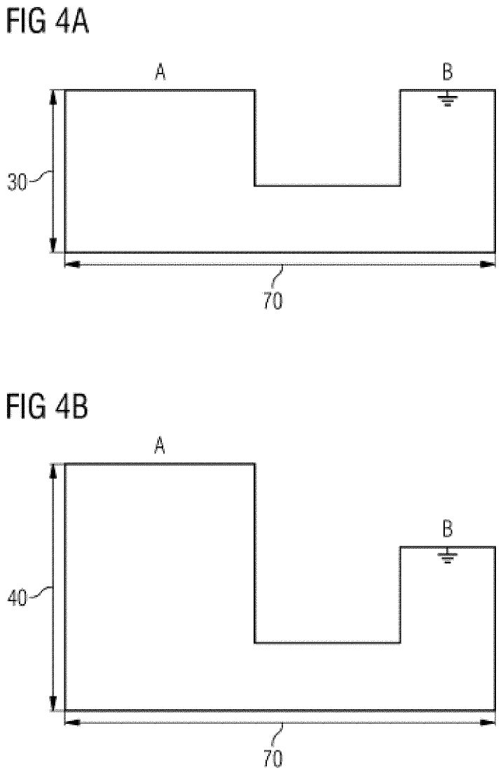

The user operation may not be possible because of conflicting (or over-defining) relationships which mean there is no solution which allows the proposed edit of the model. For example, as illustrated by the modified FIG. 2a example, it is not possible to implement the proposed user operation. The modified FIG. 2a example is illustrated in FIG. 4a (described in more detail below). The next act in a situation in which the user operation may not be implemented, is to identify the relationships preventing the user operation for being implemented (act S310), for example, by querying a solver such as the Siemens DCM solver for the over-defining relationships. These relationships may be termed “problem relationships”. These problem relationships may be a group (e.g., subset) of the full set of relationship or may be multiple groups of relationships which together contribute to the problem. It is necessary to determine which relationships within each group the user is most likely to want to remove to allow the user operation. Accordingly, the next phase is to process the problem relationships.

In a first act, each of the problem relationships may be categorized (act S312) or classified into subgroups. The subgroups may be:
user-defined relationships, e.g., relationships which have been explicitly added by a user
inherent relationships which are inherent in the model itself or implied by the user operation, including
   optional relationships, e.g., relationships that a user would more strongly prefer to keep than other inherent (e.g., non-user-defined) relationships but may be optional when implementing the user operation
   relaxed relationships, e.g., relationships that a user may like to keep but are less critical than optional relationships and may be relaxed (e.g., ignored) when implementing the user operation

Each of the categories of relationships may include simple relationships, (e.g., dimensions or simple geometric constraints), or more complex relationships, (e.g., patterns). For example, where the relationships identified above have been identified by studying the model itself rather than specified by a user, they may be categorized as:

| | Category |
|---|---|
| | (when not |
| Relationship | set by a user) |
| A dimension of a feature within a model | Optional |
| A dimension of the overall model, e.g., length, width, | Optional |
| height | |
| Two or more lines within the model remain parallel to one | Relaxed |
| another | |
| Two lines within the model remain perpendicular to one | Relaxed |
| another | |
| Two lines within the model remain colinear with one | Relaxed |
| another | |
| A pattern is applied to one or more features | Optional |
| A straight line meeting a curved surface forms a tangent | Optional |
| to the curved surface at the point of intersection (e.g., | |
| tangent at vertex) | |
| Two curved surfaces are part of concentric circles | Relaxed |
| A line within the model remains horizontal | Optional |
| A line within the model remains vertical | Optional |
| A line within the model remains in a fixed position | Optional |

In addition to the relationships identified within the model, there may be optional relationships which result from the proposed edit, for example, as described in WO2014/008220. Some examples are listed below:
The quantity of neighboring faces included in the change should be minimized by allowing faces to “tip”
Spacing between occurrences of a pattern should remain unchanged
When changing the value of a dimension (distance or angle) which drives a vertex, the faces incident at that vertex should change minimally, e.g., with most remaining fixed and only one moving

It will be appreciated that the relationships listed above are merely illustrative and there may be other relationships. The category for each type of relationship may be pre-defined or may be alterable by a user. Thus, the categorizations above are merely illustrative and the lists of relationships which fall within a category may be configurable, e.g., to meet the specifications for particular products or design criteria for a user.

Once the relationships have been categorized, actions which are specific to the category may be applied. For example, for any relationship which a user has explicitly added, the action may be to never automatically remove them. Thus, as shown in act S314, the user defined relationships are retained. The optional relationships represent those relationships that a user would prefer to keep where possible and if this is not possible, the minimal number of these relationships should be dropped. In other words, optional relationships are those which are imposed when they do not over-define the model. As set out in act S316, the optional relationships are thus sorted. The relaxed relationships represent those relationships that a user may like but when they are preventing a user operation, these relationships may be broken. As set out in act S318, the relaxed relationships are ignored which means that they are not solved and may thus be broken when generating the updated model.

The sorting of the optional relationships may include defining an order in which the optional relationships are applied. Such an order may represent a definition of the general behavior preference for the system. Any suitable method for sorting the optional relationships which minimizes the number which are removed may be used. For example, the relationships may be ordered as follows:
Order any relationships which were newly categorized (e.g., relationships identified from the model which may be termed optional model relationships) above any optional relationships which were previously categorized as optional relationships (e.g., optional relationships resulting from the user operation which may be termed optional editing relationships)
Order optional relationships which are further (e.g., more distant) from the user operation above the optional relationships which are closer to the user operation
Order more straightforward geometric constraints such as requiring lines to be horizontal or vertical, above more complex geometric constraints such as tangent at vertex
Exclude the optional relationship relating to the user operation

The relationships which were newly categorized as optional may have been categorized in the preceding act S312. The relationships which were previously categorized as optional may have been categorized in a previous iteration or may have been identified as optional relationships when the model and set of relationships were received. It will be appreciated that this is merely an illustrative sorting method and other heuristics may be inserted as needed. Sorting of optional relationships is also described in WO2014/008220 which also gives an example how to determine distance from the user operation.

The next act (S322) is to reconfigure the model and relationships based on the combination of the categorizations and the actions from acts S314 to S318. The reconfiguration act is followed by another determination as to whether or not the user operation may be implemented with the reconfigured model (act S324). The optional relationships are applied in the order from act S316. In other words, the first ordered (e.g., highest priority) relationship is applied first. When the user operation is not compatible with this first ordered relationship, the next ordered optional relationship is applied. Whether or not the user operation is compatible with this second ordered relationship, the next ordered relationship is then checked and so on so that each relationship is checked in sequence. Any optional relationships which cannot be applied are not applied but the others are retained. In an instance in which no optional relationships are applied, an alternative ordering may be derived, e.g., by changing the rules listed above or by changing the category of at least one optional relationship and repeating the ordering. Application of optional relationships is also described in WO2014/008220.

When it is determined that the user operation may be performed, the next act is to perform the user operation (act S326) and output the updated model (act S328). For example, FIG. 4b is an example of an output updated model which may be output to the user and/or stored as required. A list of any relationships which have been ignored when generating the updated model may be output to the user and/or stored together with the updated model. However, if the reconfigured model cannot be applied, for example because another over-defined region of the model is discovered when implementing the reconfigured model, the process may iterate again from act S310. Thus, the method is a propagation algorithm which acts through the model analyzing and adding geometry, relationships, dimensions, and other features as needed.

FIG. 4a illustrates the example model of FIG. 2a with the additional relationship that the position of line B is fixed. The full set of relationships is defined below:

| Relationship | Category |
|---|---|
| Horizontal dimension | User defined |
| Vertical dimension | User defined |
| Line B in fixed position | User defined |
| Colinear relationship of A, B | Implied |

As in the arrangement of FIG. 2a, the user wishes to edit the vertical dimension by moving the line A away from the base line. Applying the process described in FIG. 3, on receipt of this user operation, a determination is made that the model is over-defined because it is not possible to satisfy all the relationships listed above. In particular, three of the relationships are identified as problem relationships which are causing the model to be over-defined: the adjustment of the vertical dimension, the fixed position of line B and the colinear relationship of lines A and B. The horizontal dimension is not one of the relationships which is causing the over-definition of the model. Thus, the following three relationships in the table below are identified as problem relationships and are then categorized. In this example and using the example categorization listed above, the implied relationship is categorized as a relaxed relationship. Based on their category, an action is associated with each relationship as indicated in the table below.

| Relationship | Updated Category | Action |
|---|---|---|
| Vertical dimension | User defined | Retain |
| Line B in fixed position | User defined | Retain |
| Colinear relationship of A, B | Relaxed | Ignore |

The model is then reconfigured by implementing the actions above. The user operation is reapplied to the model. By relaxing one problem relationships as described above, the user operation may be implemented to give the updated model shown in FIG. 4b. As shown, line A is moved to a new dimension of 40 from the base line and the other elements of the model are unaltered.

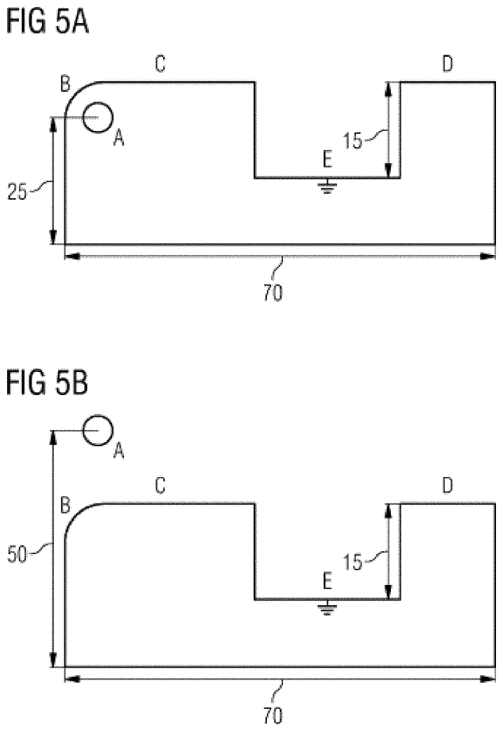

FIG. 5a illustrates a more complex example model which has a full set of relationships as defined below:

| Relationship | Category |
|---|---|
| Horizontal dimension (70) | User defined |
| First vertical dimension (25) | User defined |
| Second vertical dimension (15) | User defined |
| Line E in fixed position | User defined |
| Colinear relationship of lines C & D | Implied |
| Line C is a tangent of curve B | Implied |
| Curvature of B is defined by a circle | Implied |
| which is concentric with A | |

The user operation in this example is to edit the first vertical dimension by moving the circle A away from the base line. On receipt of this user operation, a determination is made that the model is over-defined because it is not possible to satisfy all the relationships listed above when making this edit. All the relationships, except the horizontal dimension relationship, are identified as problem relationships which are causing the model to be over-defined and are then categorized. In this example, and using the categorization list defined above, two of the implied relationships are categorized as relaxed relationships and one of the implied relationships is categorized as an optional relationship. Based on their category, an action is associated with each relationship as indicated in the table below.

| Relationship | Category | Action |
|---|---|---|
| First vertical dimension (25) | User defined | Retain |
| Second vertical dimension (15) | User defined | Retain |
| Line E in fixed position | User defined | Retain |
| Colinear relationship of lines C & D | Relaxed | Ignore |
| Line C is a tangent of curve B at the | Optional | Sort |
| point of intersection | | |
| Curvature of B is defined by a circle | Relaxed | Ignore |
| which is concentric with A | | |

The model is then reconfigured by implementing the actions above. It will be appreciated that there is only one optional constraint and thus the sorting action does not have any effect. The user operation is reapplied to the model. By relaxing two problem relationships as described above, the user operation may be implemented to give the updated model shown in FIG. 5b. As shown, the circle A is moved to a new dimension of 50 from the base line and the other elements of the model are unaltered.

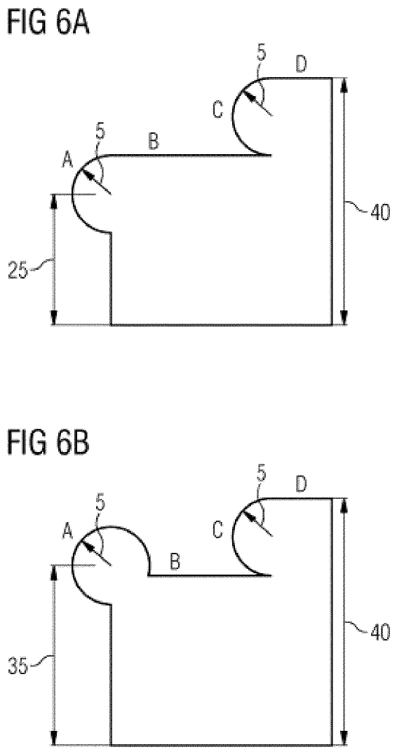

FIG. 6a illustrates another relatively complex example model and the full set of relationships is not listed. The user operation in this example is to edit the first vertical dimension by moving the arc A away from the base line. On receipt of this user operation, a determination is made that the model is over-defined because it is not possible to satisfy all the relationships listed below when making this edit. These relationships are the problem relationships causing the model to be over-defined. In this example, and using the example configuration above, all of the implied relationships are categorized as optional relationships. Based on their category, an action is associated with each relationship as indicated in the table below.

| Relationship | Category | Action |
|---|---|---|
| First vertical dimension (25) | User defined | Retain |
| Second fixed vertical dimension (40) | User defined | Retain |
| Dimension of radius of curvature A (5) | User defined | Retain |
| Dimension of radius of curvature C (5) | User defined | Retain |
| Line B is a tangent of curve A at the | Optional | Sort |
| point of intersection | | |
| Line B is horizontal | Optional | Sort |
| Line B is a tangent of curve C at the | Optional | Sort |
| point of intersection | | |
| Line D is a tangent of curve C at the | Optional | Sort |
| point of intersection | | |
| Line D is horizontal | Optional | Sort |

In this example, there are five newly converted optional relationships which need to be sorted into an order in which they will be applied. As explained above, the ordering may be defined to minimize the number of geometries which move. Applying the sorting rules which require horizontal and/or vertical relationships to be attempted before tangent at vertex relationships and also relationships which are further from the user operation to be attempted before those which are closer, an order for the optional relationships may be:

| Relationship | Category | Order |
|---|---|---|
| Line B is a tangent of curve A at the | Optional | 5 |
| point of intersection | | |
| Line B is horizontal | Optional | 2 |
| Line B is a tangent of curve C at the | Optional | 4 |
| point of intersection | | |
| Line D is a tangent of curve C at the | Optional | 3 |
| point of intersection | | |
| Line D is horizontal | Optional | 1 |

The model is then reconfigured by implementing the actions and order above. The user operation is then reapplied to the model. Each of the optional relationships may be applied except the final relationship which requires that line B is a tangent of curve A at the point of intersection of lines A and B. Accordingly, this optional relationship is ignored. The reconfigured model is thus defined as follows:

| Relationship | Category | Action |
|---|---|---|
| First vertical dimension (25) | User defined | Retain |
| Second fixed vertical dimension (40) | User defined | Retain |
| Dimension of radius of curvature A (5) | User defined | Retain |
| Dimension of radius of curvature C (5) | User defined | Retain |
| Line D is horizontal | Optional | Retain |
| Line B is horizontal | Optional | Retain |
| Line D is a tangent of curve C at the | Optional | Retain |
| point of intersection | | |
| Line B is a tangent of curve C at the | Optional | Retain |
| point of intersection | | |
| Line B is a tangent of curve A at the | Optional | Ignore |
| point of intersection | | |

By setting the non-user defined relationships as optional and ignoring one of these optional relationships, the user operation may be implemented to give the updated model shown in FIG. 6b. As shown, the circle A is moved to a new dimension of 35 from the base line and the other elements of the model are unaltered.

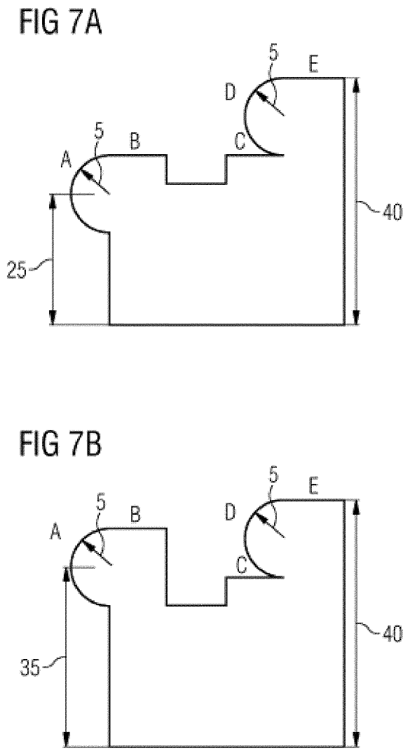

FIG. 7a illustrates a variation of the example model of FIG. 6a. The user operation in this example is to edit the first vertical dimension by moving the arc A away from the base line. On receipt of this user operation, a determination is made that the model is over-defined because it is not possible to satisfy all the problem relationships listed below when making this edit. In this example, and using the categorization above, all the implied relationships are categorized as optional relationships except for the colinear relationship between lines B and C. Based on their category, an action is associated with each relationship as indicated in the table below.

| Relationship | Category | Action |
|---|---|---|
| First vertical dimension (25) | User defined | Retain |
| Second fixed vertical dimension (40) | User defined | Retain |
| Dimension of radius of curvature A (5) | User defined | Retain |
| Dimension of radius of curvature D (5) | User defined | Retain |
| Line B is a tangent of curve A at the | Optional | Sort |
| point of intersection | | |
| Line B is horizontal | Optional | Sort |
| Colinear lines B and C | Relaxed | Ignore |
| Line C is a tangent of curve D at the | Optional | Sort |
| point of intersection | | |
| Line E is a tangent of curve D at the | Optional | Sort |
| point of intersection | | |
| Line E is horizontal | Optional | Sort |

In this example, there are five newly converted optional relationships which need to be sorted into an order in which they will be applied. Applying the sorting rules described above in relation to FIG. 6a, an order for the optional relationships may be:

| Relationship | Category | Order |
|---|---|---|
| Line ED is horizontal | Optional | 1 |
| Line B is horizontal | Optional | 2 |
| Line E is a tangent of curve D at the | Optional | 3 |
| point of intersection | | |
| Line C is a tangent of curve D at the | Optional | 4 |
| point of intersection | | |
| Line B is a tangent of curve A at the | Optional | 5 |
| point of intersection | | |

The model is then reconfigured by implementing the actions and order above.

| Relationship | Category | Action |
|---|---|---|
| First vertical dimension (25) | User defined | Retain |
| Second fixed vertical dimension (40) | User defined | Retain |
| Dimension of radius of curvature A (5) | User defined | Retain |
| Dimension of radius of curvature D (5) | User defined | Retain |
| Line D is horizontal | Optional | 1 |
| Line B is horizontal | Optional | 2 |
| Line E is a tangent of curve D at the | Optional | 3 |
| point of intersection | | |
| Line C is a tangent of curve D at the | Optional | 4 |
| point of intersection | | |
| Line B is a tangent of curve A at the | Optional | 5 |
| point of intersection | | |
| Colinear lines B and C | Relaxed | Ignore |

The user operation is then reapplied to the model. Each of the optional relationships may be applied and the relaxed relationship is ignored. The user operation may be implemented to give the updated model shown in FIG. 7b. As shown, both lines A and B are moved so that there is a new first vertical dimension of 35 from the base line and the other elements of the model are unaltered.

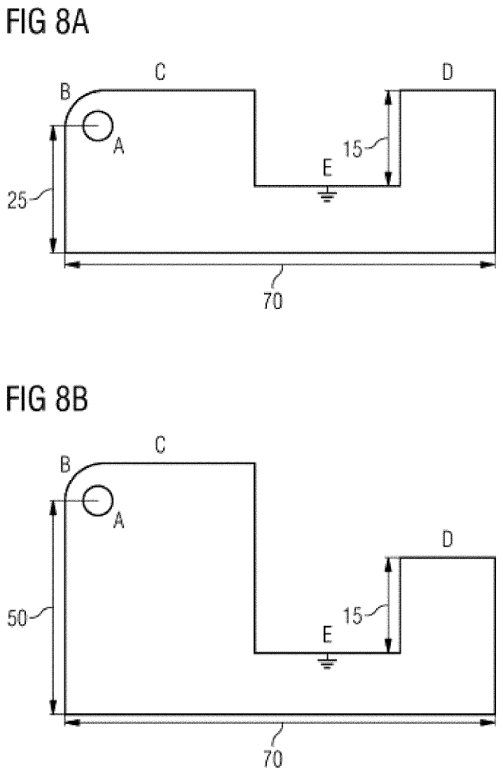

Figure Sa illustrates how changing the categorization of a relationship impacts the reconfiguration of the model. FIG. 8a is the same model as that shown in FIG. 5a and thus has a full set of relationships as defined below:

| Relationship | Category |
|---|---|
| Horizontal dimension (70) | User defined |
| First vertical dimension (25) | User defined |
| Second vertical dimension (15) | User defined |
| Line B in fixed position | User defined |
| Colinear relationship of lines C & D | Implied |
| Line C is a tangent of curve B | Implied |
| Curvature of B is defined by a circle | Implied |
| which is concentric with A | |

As previously, the user operation is to edit the first vertical dimension by moving the arc A away from the base line. All the relationships, except the horizontal dimension relationship, are identified as problem relationships which are causing the model to be over-defined and are then categorized. In this example, the general rule is that concentric relationships are to be categorized as optional relationships rather than relaxed relationships. Accordingly, two of the implied relationships are categorized as optional relationships and one of the implied relationships is categorized as a relaxed relationship. Based on their category, an action is associated with each relationship as indicated in the table below.

| Relationship | Category | Action |
|---|---|---|
| First vertical dimension (25) | User defined | Retain |
| Second vertical dimension (15) | User defined | Retain |
| Line B in fixed position | User defined | Retain |
| Colinear relationship of lines C & D | Relaxed | Ignore |
| Line C is a tangent of curve B at the | Optional | Sort |
| point of intersection | | |
| Curvature of B is defined by a circle | Optional | Sort |
| which is concentric with A | | |

In this example, there are two newly converted optional relationships which need to be sorted into an order in which they will be applied. Applying the sorting rules described above, the relationships are ordered as:

| Relationship | Category | Order |
|---|---|---|
| Line C is a tangent of curve B at the | Optional | 1 |
| point of intersection | | |
| Curvature of B is defined by a circle | Optional | 2 |
| which is concentric with A | | |

The model is then reconfigured by implementing the actions above.

| Relationship | Category | Action |
|---|---|---|
| Horizontal dimension (70) | User defined | Retain |
| First vertical dimension (25) | User defined | Retain |
| Second vertical dimension (15) | User defined | Retain |
| Line B in fixed position | User defined | Retain |
| Line C is a tangent of curve B | Optional | Order 1 |
| Curvature of B is defined by a circle | Optional | Order 2 |
| which is concentric with A | | |
| Colinear relationship of lines C & D | Relaxed | Ignored |

The user operation is reapplied to the model. By relaxing only one problem relationship, the user operation may be implemented to give the updated model shown in FIG. 8b. As shown, the circle A is moved to a new dimension of 50 from the base line and is retained in the same location relative to lines B and C which are also moved upwards. The other elements of the model are unaltered.

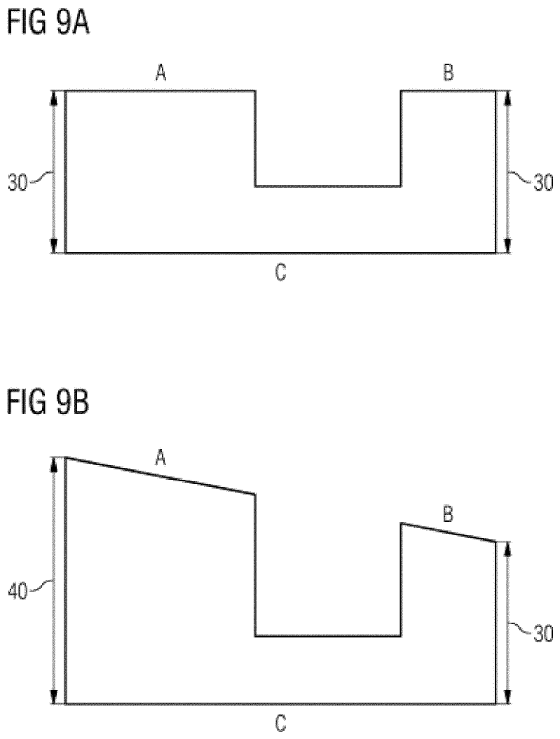

FIG. 9a illustrates how changes to the user-defined relationships impact a user operation on a reconfigured model. FIG. 9a is the same model as that shown in FIG. 2a but the co-linear relationship between lines A and B is now a user-defined relationship and the vertical dimension between lines B and C is fixed. The full set of relationships is defined below:

| Relationship | Category |
|---|---|
| First vertical dimension (30) | User defined |
| Second fixed vertical dimension (30) | User defined |
| Colinear relationship of A, B | User defined |
| Line A is horizontal | Implied |
| Line B is horizontal | Implied |
| Line C is horizontal | Implied |

As in the arrangement of FIG. 2a, the user wishes to edit the first vertical dimension by moving the line A away from the base line C. On receipt of this user operation, a determination is made that the model is over-defined because it is not possible to satisfy all the relationships listed above. All relationships are identified as problem relationships which are causing the model to be over-defined. The relationships are then categorized. In this example, all the implied relationships are categorized as optional relationships because each relationship relates to the horizontal nature of a line. Based on their category, an action is associated with each relationship as indicated in the table below.

| Relationship | Category | Action |
|---|---|---|
| First vertical dimension (30) | User defined | Retain |
| Second fixed vertical dimension (30) | User defined | Retain |
| Colinear relationship of A, B | User defined | Retain |
| Line A is horizontal | Optional | Sort |
| Line B is horizontal | Optional | Sort |
| Line C is horizontal | Optional | Sort |

There are three optional relationships which need to be sorted. Applying the sorting described above, e.g., with the relationships which are furthest from the edit being ordered higher in the sequence, the following order is obtained.

| Relationship | Category | Order |
|---|---|---|
| Line C is horizontal | Optional | 1 |
| Line B is horizontal | Optional | 2 |
| Line A is horizontal | Optional | 3 |

The model is then reconfigured by implementing the actions above to give the following set of relationships.

| Relationship | Category | Action |
|---|---|---|
| First vertical dimension (30) | User defined | Retain |
| Second fixed vertical dimension (30) | User defined | Retain |
| Colinear relationship of A, B | User defined | Retain |
| Line C is horizontal | Optional | Order 1 |
| | | (Retain) |
| Line B is horizontal | Optional | Order 2 |
| | | (Do not retain) |
| Line A is horizontal | Optional | Order 3 |
| | | (Do not retain) |

The user operation is reapplied to the model. As previously, the optional relationships may be applied as described in WO2014/008220. After the retained relationships have been applied, the optional relationship having order 1 is applied first. This optional relationship may be imposed and is thus retained as indicated in brackets in the table above. The next ordered optional relationship is then applied. However, it is not possible to keep line B horizontal and satisfy the other retained relationships. Accordingly, this optional relationship is not retained as indicated in brackets in the table above. The next ordered optional relationship is then applied. Similarly, it is not possible to keep line A horizontal and satisfy the other retained relationships. Accordingly, this optional relationship is not retained. The user operation may be implemented with four retained relationships and two ignored relationships to give the updated model shown in FIG. 9b. As shown, line A is moved to a new dimension of 40 from the base line, lines A and B are set at an angle away from horizontal but are still colinear. The other elements of the model are unaltered.

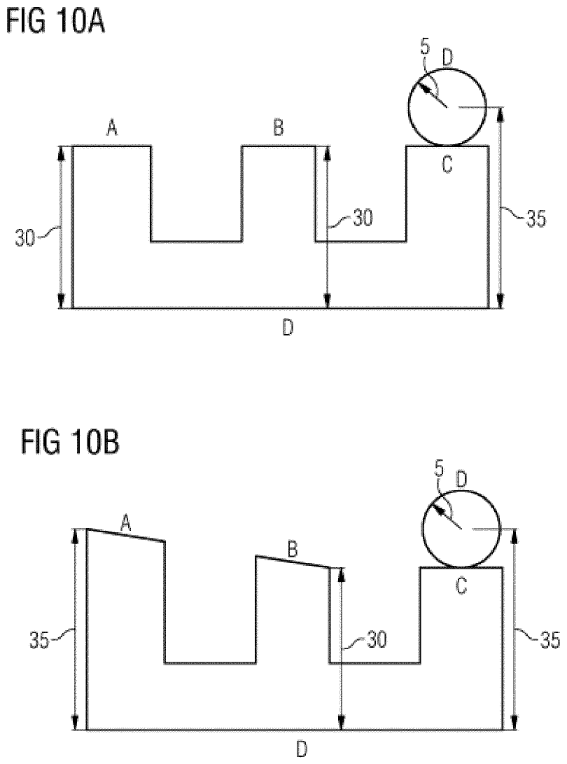

FIG. 10a illustrates another relatively complex example model and the full set of relationships is not listed. This example shows how the system deals with situations where multiple iterations through the process are required. The user operation in this example is to edit the left-hand side vertical dimension by moving the planar surface A away from the base line. On receipt of this user operation, a determination is made that the model is over-defined because it is not possible to satisfy all the relationships listed below when making this edit. As shown below, some of these relationships are user-defined and others are implied. In this example and using the example configuration above, all of the implied relationships are categorized as optional relationships. Based on their category, an action is associated with each relationship as indicated in the table below.

| Relationship | Category | Action |
|---|---|---|
| Left side dimension is 30 | User defined | Being edited |
| Middle dimension is 30 | User defined | Retain |
| Co-linear relationship between | User defined | Retain |
| lines A and B | | |
| Line A is horizontal | Optional | Sort |
| Line B is horizontal | Optional | Sort |
| Line D is horizontal | Optional | Sort |

It is also noted that there are other relationships, e.g., the right-side dimension is 35 and the radius of circle D is 5. However, these relationships are not within the set of problem relationships because they are not preventing the edit from being made.

In this example, there are three newly converted optional relationships which need to be sorted into an order in which they will be applied. As explained above, the ordering may be defined to minimize the number of geometries which move. Applying the sorting rules which require horizontal and/or vertical relationships to be attempted before tangent at vertex relationships and also relationships which are further from the user operation to be attempted before those which are closer, an order for the optional relationships may be:

| Relationship | Category | Order |
|---|---|---|
| Line A is horizontal | Optional | 3 |
| Line B is horizontal | Optional | 2 |
| Line D is horizontal | Optional | 1 |

The model is then reconfigured by implementing the actions and order above. The user operation is then reapplied to the model. Line D may be maintained in a horizontal position, but A and B cannot be maintained in a horizontal position and satisfy the other relationships. Accordingly, these relationships are ignored. The reconfigured model is thus defined as follows:

| Relationship | Category | Action |
|---|---|---|
| Left side dimension is 30 | User defined | Being edited |
| Middle dimension is 30 | User defined | Retain |
| Co-linear relationship between | User defined | Retain |
| lines A and B | | |
| Line A is horizontal | Optional | Ignore |
| Line B is horizontal | Optional | Ignore |
| Line D is horizontal | Optional | Retain |

The system then attempts to implement the user operation using the reconfigured model above, but a new set of problem relationships is identified which prevent the user operation. As shown below, some of these relationships are user-defined and others are implied. In this example, and using the example configuration above, two of the implied relationships are categorized as optional relationships and one as relaxed. Based on their category, an action is associated with each relationship as indicated in the table below.

| Relationship | Category | Action |
|---|---|---|
| Left side dimension is 30 | User defined | Being edited |
| Right side dimension is 35 | User defined | Retain |
| Radius of circle D is 5 | User defined | Retain |
| Co-linear relationship between | Relaxed | Ignore |
| lines A and C | | |
| Line C is horizontal | Optional | Sort |
| Line C meets circle D at a tangent | Optional | Sort |

Applying the sorting rules which require horizontal and/or vertical relationships to be attempted before tangent at vertex relationships and also relationships which are further from the user operation to be attempted before those which are closer, an order for the optional relationships may be:

| Relationship | Category | Order |
|---|---|---|
| Line C is horizontal | Optional | 1 |
| Line C meets circle D at a tangent | Optional | 2 |

The model is then reconfigured by implementing the actions and order above. The user operation is then reapplied to the model. Both optional relationships may be implemented. The full set of relationships which includes both the first set of problem relationships and the second set of problem relationships is defined as

| Relationship | Category | Action |
|---|---|---|
| Left side dimension is 30 | User defined | Being edited |
| Middle dimension is 30 | User defined | Retain |
| Right side dimension is 35 | User defined | Retain |
| Radius of circle D is 5 | User defined | Retain |
| Co-linear relationship between | User defined | Retain |
| lines A and B | | |
| Line A is horizontal | Optional | Ignore |
| Line B is horizontal | Optional | Ignore |
| Line D is horizontal | Optional | Retain |
| Co-linear relationship between | Relaxed | Ignore |
| lines A and C | | |
| Line C is horizontal | Optional | Sort |
| Line C meets circle D at a tangent | Optional | Sort |

This reconfigured model gives the updated model shown in FIG. 10b. As shown, lines A and B remain parallel to one another but are no longer horizontal so that the left-hand side dimension may be increased to 35. The other elements of the model are unaltered.

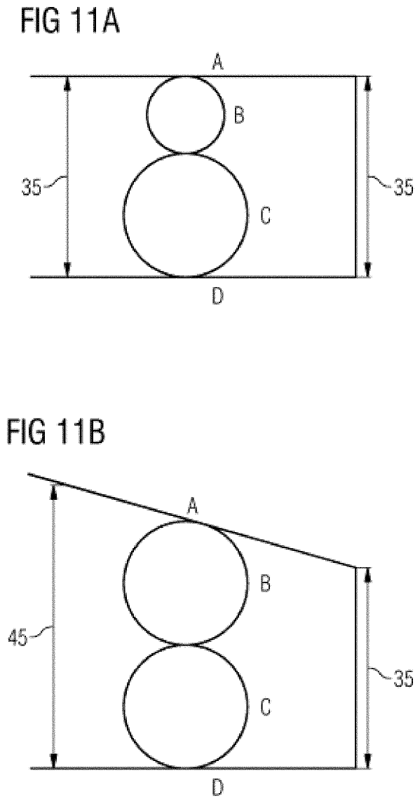

FIG. 11a illustrates another example model and shows how the system deals with different types of optional relationships. The user operation in this example is to edit the left-hand side vertical dimension by moving the line A away from the base line. The following relationships within the model are discovered

| Relationship | Category |
|---|---|
| Left-hand vertical dimension (35) | User defined |
| Right-hand vertical dimension (35) | User defined |
| Line A meets circle B at a tangent | Implied |
| Circle B meets circle C at a tangent | Implied |
| Line D meets circle C at a tangent | Implied |
| Line A is horizontal | Implied |
| Line D is horizontal | Implied |

As explained above, in addition to identifying relationships which are implied by the model, there is a consideration of relationships which may be related to the proposed edit. For example, the line A which is to be moved is in contact with circle B and the system may identify that desirable relationships are to keep the radius of circle B and its adjacent circle C constant. These two relationships are categorized as optional.

On receipt of this user operation, a determination is made that the model is over-defined because it is not possible to satisfy all the relationships listed below when making this edit. As shown below, some of these relationships are user-defined, the implied relationships have all been newly categorized as optional and there are the two additional optional relationships. Based on their category, an action is associated with each relationship as indicated in the table below.

| Relationship | Category | Action |
|---|---|---|
| Left side dimension is 35 | User defined | Being edited |
| Right side dimension is 35 | User defined | Retain |
| Line A is horizontal | Optional | Sort |
| Line D is horizontal | Optional | Sort |
| Fix radius of circle B | Optional | Sort |
| Fix radius of circle C | Optional | Sort |

It is also noted that there are other relationships, e.g., the tangential relationships. However, these relationships are not within the set of problem relationships because they are not preventing the edit from being made.

In this example, there are two newly converted optional relationships which need to be sorted into an order in which they will be applied. As explained above, the newly converted optional relationships may be ordered ahead of the other optional relationships. Applying the sorting rules above, an order for the optional relationships may be:

| Relationship | Category | Order |
|---|---|---|
| Line D is horizontal | Optional | 1 |
| Line A is horizontal | Optional | 2 |
| Fix radius of circle C | Optional | 3 |
| Fix radius of circle D | Optional | 4 |

The model is then reconfigured by implementing the actions and order above. The user operation is then reapplied to the model. Line D may be maintained in a horizontal position, but line A cannot be maintained in a horizontal position. Similarly, the radius of circle C may be maintained, but the radius of circle D must change. The full set of problem relationships and corresponding action is defined in the table below as:

| Relationship | Category | Action |
|---|---|---|
| Left side dimension is 35 | User defined | Being edited |
| Right side dimension is 35 | User defined | Retain |
| Line A is horizontal | Optional | Ignore |
| Line D is horizontal | Optional | Retain |
| Fix radius of circle B | Optional | Ignore |
| Fix radius of circle C | Optional | Retain |

This reconfigured model gives the updated model shown in FIG. 11b. As shown, line A is now at an angle to line D and the radius of circle B has increased. The other elements of the model are unaltered.

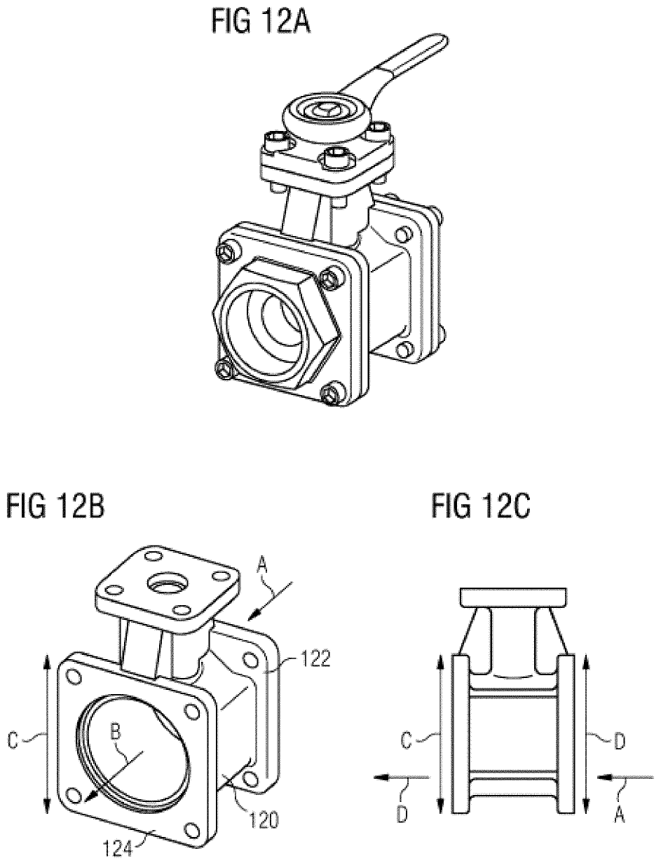

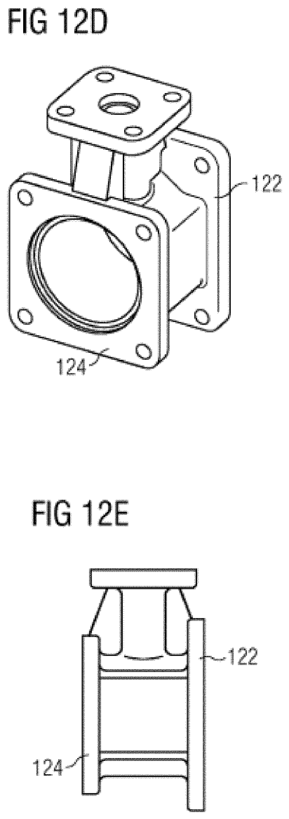

The examples shown above are 2D models, but it will be appreciated that the method described above is applicable to 3D models. The examples above are also simplified line drawings to illustrate how the method is applied in different circumstances but it will be appreciated that the CAD model is representative of a product being designed. FIGS. 12a to 12c illustrate an example of a product which may be designed using the method described above. FIG. 12a shows a valve assembly which may be used in an industrial machine and FIGS. 12b and 12c are perspective and side views of the central component 120 of the valve assembly.

As shown in FIGS. 12b and 12c, fluid may flow into an inlet of the central component 120 in the direction of arrow A, through the central component 120, and out an outlet in the direction of arrow B. As shown in FIG. 12b, the inlet and outlet are the same size. However, in this example, engineering considerations may require a change so that the couplings are no longer symmetric. For example, as indicated by Arrow C, the dimension of the outlet connector plate 122 may be required to increase but the dimension of the inlet connector plate 124 may be fixed as indicated by line D in FIG. 12c. The following relationships within the model are discovered:

| Relationship | Category |
|---|---|
| Fixed Inlet connector plate dimension | User defined |
| Fixed Outlet connector plate dimension | User defined |
| Symmetrical inlet connector plate | Implied |
| Symmetrical outlet connector plate | Implied |
| Identical size of inlet and outlet connector plate | Implied |
| Co-axial inlet and outlet | Implied |

On receipt of the user operation to increase the size of the outlet dimension, a determination is made that the model is over-defined because it is not possible to satisfy all the relationships listed above when making this edit. Categories and actions are associated with the relationships as defined above:

| Relationship | Category | Action |
|---|---|---|
| Fixed Inlet connector plate dimension | User defined | Being edited |
| Fixed Outlet connector plate dimension | User defined | Retain |
| Symmetrical inlet connector plate | Optional | Sort |
| Symmetrical outlet connector plate | Optional | Sort |
| Identical size of inlet and outlet connector | Optional | Sort |
| plate | | |
| Co-axial inlet and outlet | Optional | Sort |

The optional relationships are sorted, and the co-axial relationship is applied before the symmetrical relationships which are applied before the identical size relationship. The co-axial and symmetrical relationships may be maintained but it is not possible to maintain the identical sizes and thus this is ignored. The full set of problem relationships and corresponding action is defined in the table below as:

| Relationship | Category | Action |
|---|---|---|
| Fixed Inlet connector plate dimension | User defined | Being edited |
| Fixed Outlet connector plate dimension | User defined | Retain |
| Symmetrical inlet connector plate | Optional | Retain |
| Symmetrical outlet connector plate | Optional | Retain |
| Identical size of inlet and outlet | Optional | Ignore |
| connector plate | | |
| Co-axial inlet and outlet | Optional | Retain |

This reconfigured model gives the updated model shown in FIGS. 12d and 12e. As shown, connector plate 124 is now larger. The other elements of the model are unaltered. The process thus allows the relationships between the inlet and outlet sides to be broken as required but the important symmetrical and co-axial relationships are retained. The result is a correctly modified component which is achieved in a relatively straightforward manner. A list of the relationships which have been maintained and those which have been broken may also be provided to the user.

The disclosed embodiments enable a user to perform accurate and intuitive editing of CAD models taking into account the desired behavior of the models, e.g., by considering relationships between features and other constraints on the model. The behavior may be defined by the user, implied by the model or by the proposed user operation. Some user operations may not be implementable because the behavior is over-constrained. By categorizing relationships as optional or relaxed, it is possible to automatically ignore (e.g., relax) a minimal number of relationships to allow the proposed user operation to be carried out. This may be an improvement on a system which simply informs the user that the user operation cannot be carried out. The user may be informed of the relationships which have been ignored when creating the updated output and thus has control over whether or not to implement the user operation.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for designing a product using a computer-aided design (CADI model, the method being implemented in a data processing system and comprising:
receiving a CAD model having a behavior defined by a plurality of relationships;
receiving a user operation to edit a seed feature in the CAD model;
identifying a set of problem relationships from the plurality of relationships, wherein the set of problem relationships prevent implementation of the received user operation to the received CAD model;
selecting a category for each relationship in the set of problem relationships, wherein the category is selected from user-defined, optional, and relaxed relationships, wherein a user-defined relationship is a relationship defined by the user, and wherein optional and relaxed relationships are relationships not defined by the user with optional relationships representing more important behavior than the relaxed relationships;
reconfiguring the behavior of the CAD model based on the selected category for each problem relationship by:
retaining any user-defined relationships;
optionally retaining any optional relationships; and
ignoring any relaxed relationships; and
performing the user operation according to the reconfigured behavior to produce a modified CAD model.

2. The method of claim 1, further comprising:
identifying a second set of problem relationships in the reconfigured behavior, wherein the second set of problem relationships prevent the user operation being performed; and
repeating the selecting of the category, the reconfiguring of the behavior, and the performing of the user operation.

3. The method of claim 1, wherein, the selecting of the category from optional and relaxed relationships comprises selecting the category from a look-up table listing relationships as optional or relaxed.

4. The method of claim 1, wherein the optionally retaining of any optional relationships comprises;
sorting the optional relationships into an order in which the optional relationships are to be applied;
applying a sorted optional relationship which is first in the order in which the optional relationships are to be applied;
retaining the applied sorted optional relationship only when applying the relationship does not prevent the user operation; and
repeating the applying and retaining steps to the sorted optional relationship which is next in the order in which the optional relationships are to be applied until all optional relationships have been applied.

5. The method of claim 4, wherein the sorting of the optional relationships is performed according to a distance from the seed feature to features corresponding to each of the optional relationships.

6. The method of claim 4, wherein the optional relationships comprise optional model relationships inherent from the model and optional editing relationships inherent from the user operation, and
wherein the sorting of the optional relationships is performed to prioritize optional editing relationships before optional model relationships in the order in which the optional relationships are to be applied.

7. The method of claim 1, further comprising:
storing the modified CAD model.

8. The method of claim 1, further comprising:
outputting any optional or relaxed relationships which are broken when performing the user operation.

9. A non-transitory computer readable medium carrying processor control code which, when implemented in a system, causes the system to:
receive a computer-aided design (CAD) model having a behavior defined by a plurality of relationships;
receive a user operation to edit a seed feature in the CAD model;
identify a set of problem relationships from the plurality of relationships, wherein the set of problem relationships prevent implementation of the received user operation to the received CAD model;
select a category for each relationship in the set of problem relationships, wherein the category is selected from user-defined, optional, and relaxed relationships, wherein a user-defined relationship is a relationship defined by the user, and wherein optional and relaxed relationships are relationships not defined by the user with optional relationships representing more important behavior than the relaxed relationships;
reconfigure the behavior of the CAD model based on the selected category for each problem relationship by:
retain any user-defined relationships;
optionally retain any optional relationships; and
ignore any relaxed relationships; and
perform the user operation according to the reconfigured behavior to produce a modified CAD model.

10. A data processing system for designing a product using a computer-aided design (CAD) model, the system comprising:
a processor configured to:
receive a CAD model having a behavior defined by a plurality of relationships;
receive a user operation to edit a seed feature in the CAD model;
identify a set of problem relationships from the plurality of relationships, wherein the set of problem relationships prevent implementation of the received user operation to the received CAD model;
select a category for each relationship in the set of problem relationships, wherein the category is selected from user-defined, optional, and relaxed relationships, wherein a user-defined relationship is a relationship defined by the user, and wherein optional and relaxed relationships are relationships not defined by the user with optional relationships representing more important behavior than the relaxed relationships;
reconfigure the behavior of the CAD model based on the selected category for each problem relationship by:
retaining any user-defined relationships;
optionally retaining any optional relationships; and
ignoring any relaxed relationships; and
perform the user operation according to the reconfigured behavior to produce a modified CAD model.

11. The data processing system of claim 10, further comprising:
a memory for storing the modified CAD model.

12. The data processing system of claim 11, wherein the memory is configured to store a look-up table listing relationships as optional or relaxed, and
wherein the processor is configured to select the category from the optional and relaxed relationships by selecting the category from the look-up table.

13. The data processing system of claim 10, further comprising:
a display configured to output any optional or relaxed relationships which are broken when performing the user operation.

14. The data processing system of claim 10, further comprising:
a display configured to output the modified CAD model.

15. The data processing system of claim 10, wherein the product is a component of a valve assembly, a component of an engine, a gear in a gear assembly, a component of an electric motor, or a component from a washing machine.

16. The data processing system of claim 11, further comprising:
a display configured to output any optional or relaxed relationships which are broken when performing the user operation.

17. The data processing system of claim 16, wherein the display is further configured to output the modified CAD model.

18. The data processing system of claim 11, further comprising:
a display configured to output the modified CAD model.

19. The method of claim 2, further comprising:
storing the modified CAD model.

20. The method of claim 19, further comprising:
outputting any optional or relaxed relationships which are broken when performing the user operation.
